(19) United States
(12) Patent Application Publication
(10) Pub. No.: US 2004/0120755 A1
(43) Pub. Date: Jun. 24, 2004

(54) Multi-axis coupler

(76) Inventor: George H. Butler III, Mesa, AZ (US)

Correspondence Address: THOMPSON COBURN, LLP, ONE US BANK PLAZA, SUITE 3500, ST LOUIS, MO, 63101, US

(21) Appl. No.: 10/322,873

(22) Filed: Dec. 18, 2002

(51) Int. Cl. F16D 1/12

(52) U.S. Cl. 403/52

(57) ABSTRACT

A coupler for connecting rotary members to facilitate transfer of torque between the members where the rotational axes of the members are not in axial alignment.

### SUMMARY OF THE INVENTION

This invention is directed to a coupler for interconnecting rotary members in order to facilitate relative motion between them as they transmit torque where the rotational axes of the members are out of axial alignment.

More specifically, the coupler comprises a female portion that extends from one of the members, and a male portion that extends from the other of the members. The female portion has at least one axially extending interior wall defining a socket. The interior wall includes at least one head-engaging surface portion. The male portion has a neck and a head. The head includes at least one wall-engaging surface portion. The head is sized and adapted to be received in the socket. The female portion and the male portion are shaped and adapted such that with the male portion positioned in the female portion and the members rotated, the wall-engaging surface portion is in engagement with the head-engaging surface portion such that rotation of one member about its axis imparts rotation to the other member about its axis even with the axes out of axial alignment.

Another aspect of the present invention is a method of rotating a first member to impart rotation to a second member. The, method includes providing a coupler as previously described, and further includes inserting the male portion in the female portion and rotating the first member about its axis while the wall engaging surface portion is in engagement with the head engaging surface portion to cause the second member to rotate about its axis even with the axes out of axial alignment.

Other features and advantages will be apparent from the description and claims to follow.

### BRIEF DESCRIPTION OF THE DRAWINGS

FIG. 1 is a perspective view of an embodiment of the coupler of the invention showing the male and female portions;

FIG. 2 is a perspective view with a cutaway portion of the coupler of FIG. 1 in a connected configuration and with the axes of the male and female portions out of alignment;

FIG. 3 is a front plan view of the coupler of FIG. 1 in a connected configuration;

FIG. 4a is a cross-section view taken along line 4-4 of FIG. 3;

FIG. 4b is a view like FIG. 4a but showing the head of the male portion in engagement with the wall of the female portion where rotation of one imparts rotation to the other;

FIG. 5 is a front plan view of the male portion of FIG. 1;

FIG. 6 is a front plan view of the female portion of FIG. 1;

FIGS. 7a and 7b are schematics showing the relationships between the male and female portions at different positions of rotation; and

FIG. 8 is a cross section view showing a retainer in accordance with the invention.

Corresponding reference characters indicate corresponding parts throughout the several views of the drawings.

### DETAILED DESCRIPTION OF THE PREFERRED EMBODIMENTS

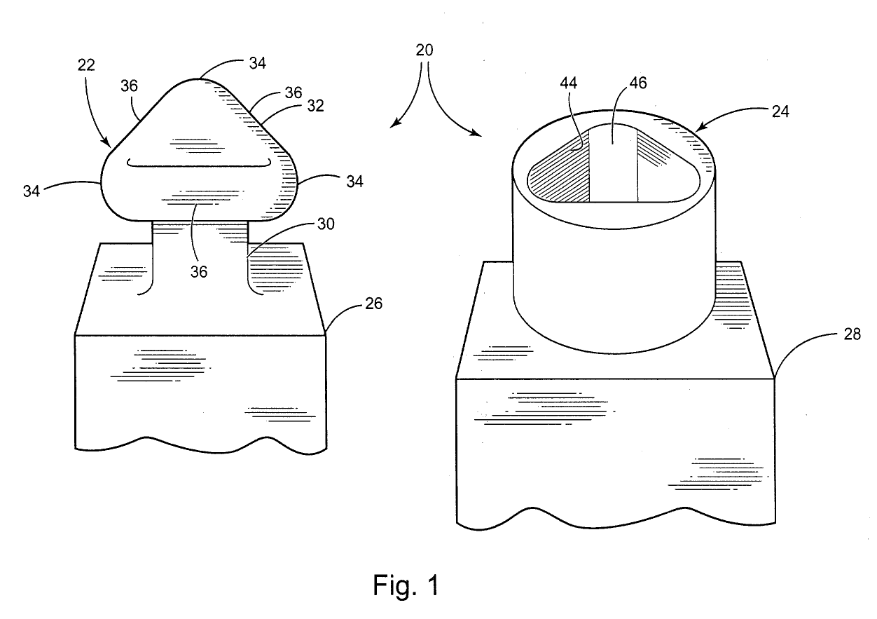

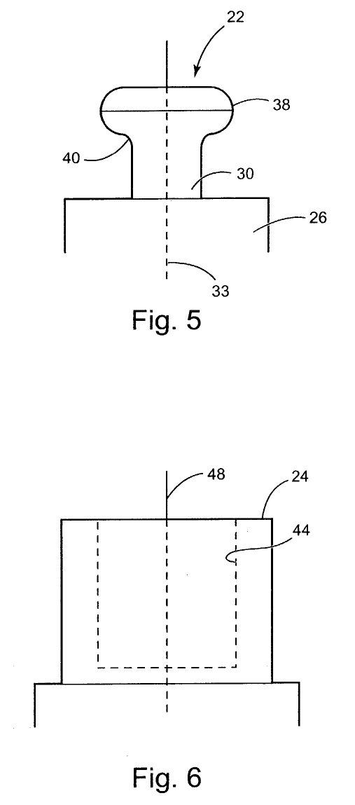

Referring to the drawings, FIG. 1 shows a coupler 20 of the present invention. The coupler includes a male portion 22 and a female portion 24 extending from first and second members 26, 28, respectively. Although the male portion is shown associated with the member 26 and the female portion with the member 28, it is to be understood that the male or female portion may be associated with either member. The male portion 22 has a neck 30 and an enlarged head 32. As shown in the drawings, and particularly FIG. 5, the head of this described embodiment is of a generally triangular shape when viewed in a plane perpendicular to the rotational axis 33 of the male portion, forming three rounded lobes 34 joined by generally straight portions 36 between the lobes. The lobes 34 are symmetrical about the rotational axis of the male portion. The head has a smooth outer circumferential surface 38 that is rounded as shown, for example in FIG. 5. The junction between the neck and head is formed by a smooth radius 40.

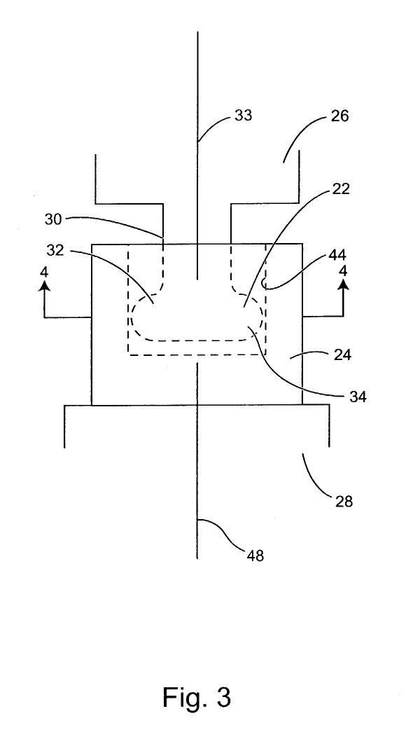

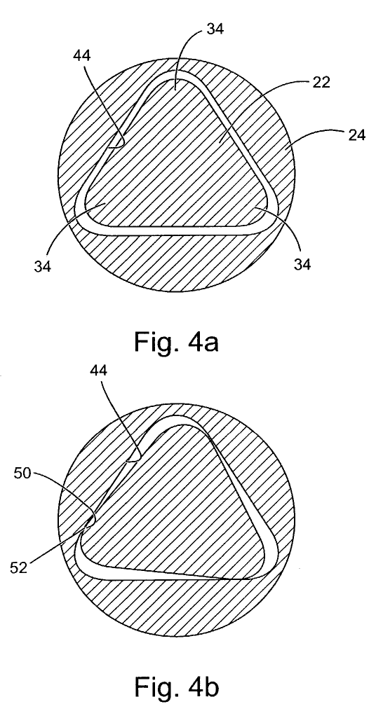

The female portion 24 has an interior wall 44 that forms a socket 46 that receives the head of the male portion. In this described embodiment, the shape of the socket when viewed in a plane perpendicular to the rotational axis 48 of the female portion is generally triangular to correspond with the generally triangular shape of the head of the male portion, and the socket is symmetrical about the rotational axis of the female portion. The socket and head are sized such that with the head inserted in the socket there is clearance between the rounded circumferential surface of the head and the socket wall as shown in FIG. 4a. Also, the socket is of sufficient depth so as to provide a range of longitudinal (axial) positions of the head within the socket while still providing rotational engagement (see, for example, FIG. 3).

In this described embodiment of the invention, the male and female portions each are of monolithic construction, although it is to be understood that other types of construction may also be used for either or both components. Also, it is to be understood that the male and female components may be formed from various materials, depending on the applications for which they are used, and it further is to be understood that the male and female components need not necessarily be formed of the same materials, it being preferred that the particular construction and materials be selected to provide minimum wear and maximum life taking into account cost considerations for a particular application. Also, while with this described embodiment the head and socket are of generally triangular configurations, it is to be understood that other suitable configurations could also be used depending on the particular application for the coupler.

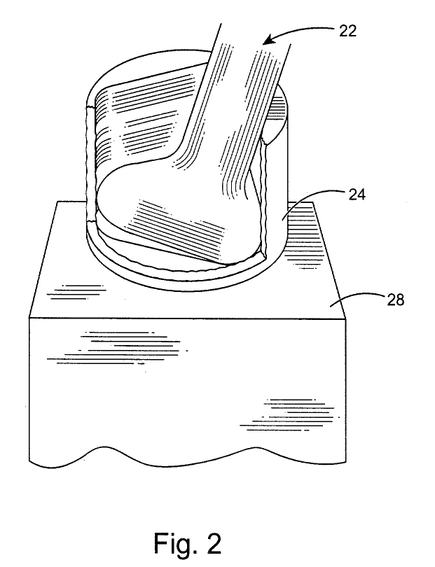

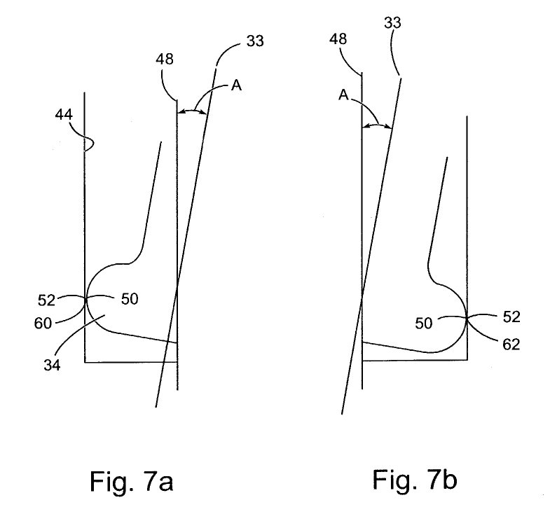

In operation, the coupler is assembled by inserting the head of the male portion into the socket of the female portion. As shown in FIGS. 2 and 7, the rotational axes of the male and female portions can be out of axial alignment as shown by the angle A (FIG. 7). As shown in FIG. 4a, there is sufficient clearance between the head and socket to allow for easy insertion of the head into the socket. After the coupler is assembled, initial rotation of one of the members 26, 28 will cause the male or female portion to rotate relative to the other until wall-engaging surface portions 50 of the male portion engage head-engaging surface portions 52 of the female portion as shown in FIG. 4b. Continued rotation of the one member (drive member) imparts rotation to the other member (driven member) even with the axes of the two members out of alignment as shown in FIGS. 2 and 7. As the members rotate, the outer rounded surfaces of the lobes slide in the axial direction along the socket wall as shown in FIGS. 7a and 7b. FIG. 7a shows the position of one of the lobes 34 at a first rotational position of the coupler with its rounded outer surface contacting the wall of the socket at a location 60, while FIG. 7b shows the same lobe 34 with its outer surface contacting the wall of the socket at a different location 62 at a second rotational position of the coupler. It will be noted that during rotation from the position of FIG. 7a to the position of FIG. 7b, the lobe slides along the cavity wall in an axial direction to accommodate the axial misalignment of the rotating members. As the rotation continues through a complete revolution, the lobe shown in FIG. 7 will move axially in the other direction to return to the position shown in FIG. 7a. This back and forth axial sliding of each of the three lobes is continuous as the members rotate to accommodate for the misalignment of the rotating axes of the members. The engaging surface of the male and female portions should be smooth to minimize friction. Thus, it is important that the shape of the male and female portions must be such that rotation of one of the members 26, 28 imparts rotation to the other of the members even though their rotating axes are out of alignment.

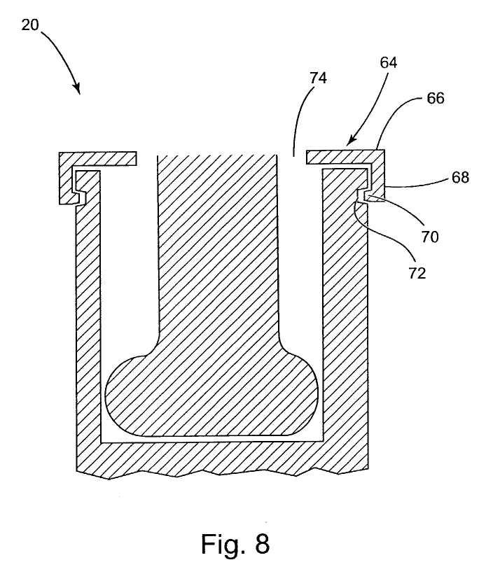

With reference to FIG. 8, there is shown a retainer 64 that may be used with the coupler of this invention. The retainer is generally a ring-shaped device that, in this described embodiment, attaches to the female portion and includes an annular wall 66, an outer circumferential wall 68, and an annular rim 70. The annular rim extends into a mating annular groove 72 in the outer wall of the female portion near its open end to hold the retainer in place. The annular wall 66 defines an opening 74 which is larger than a cross-section of the neck and smaller than the maximum cross-sectional dimension of the head of the male portion, taken perpendicular to the axis of the male portion, such that the opening is large enough to allow the male portion to be angled relative to the female portion and still allow rotation, while small enough to prevent the head from withdrawing from the socket, thereby preventing decoupling of the coupler.

The coupler of this invention can be adapted for use in a variety of applications for imparting rotation of one member to another with the axes of the members out of alignment.

As various changes could be made in the above constructions and methods without departing from the scope of the invention, it is intended that all matter contained in the above description or shown in the accompanying drawings shall be interpreted as illustrative and not in a limiting sense. Thus, the breadth and scope of the present invention should not be limited by any of the above-described exemplary embodiments, but should be defined only in accordance with the following claims appended hereto.

What is claimed is:

1. A coupler for rotatably coupling a first member having a first rotational axis to a second member having a second rotational axis, with said axes out of axial alignment, said coupler comprising:
a female portion extending from one of the members, the female portion having at least one axially extending interior wall defining a socket, the wall having at least one head-engaging surface portion;
a male portion extending from the other of the members, the male portion having a neck and a head, the head having at least one wall-engaging surface portion and being sized and adapted to be received in the socket;
the female portion and the male portion being shaped and adapted such that with the male portion positioned in the female portion and the members rotated, the wall-engaging surface portion engages the head-engaging surface portion and rotation of one member about its axis imparts rotation to the other member about its axis even with the axes out of axial alignment.

2. A coupler as set forth in claim 1 wherein the socket is of a depth to accommodate a range of longitudinal positions of the head within the socket.

3. A coupler as set forth in claim 1 further comprising:
a retainer located on one of the male and female portions, the retainer being shaped and adapted to prevent decoupling of the coupler during rotation.

4. A coupler as set forth in claim 1 wherein the male and female portions of the coupler are each of a monolithic construction.

5. The coupler as set forth in claim 1 wherein:
the male and female portions are shaped and adapted such that upon rotation of the two portions with their axes out of alignment, the wall-engaging surface portion of the male portion moves axially along the interior wall of the female portion.

6. A coupler as set forth in claim 1 wherein the head of the male portion is larger than the neck in a cross-sectional dimension taken perpendicular to the rotating axis of the male portion.

7. The coupler as set forth in claim 1 wherein said head has at least two wall-engaging surface portions in symmetry about the rotational axis of the male portion, and the female portion has at least two head-engaging surface portions in symmetry about the rotational axis of the female portion, the wall-engaging surface portions engaging the head-engaging surface portions as the members rotate.

8. A coupler as set forth in claim 1 wherein said head has three wall-engaging surface portions in symmetry about the rotational axis of the male portion, and the female portion has three head-engaging surface portions in symmetry about the rotational axis of the female portion, the wall-engaging surface portions engaging the head-engaging surface portions upon rotation of the members.

9. A coupler as set forth in claim 1 further comprising said head having rounded periphery surface portions that engage the head-engaging surface portions of the female portion during rotation of the members.

10. A coupler as set forth in claim 1 wherein the head of the male portion has a plurality of lobes in symmetry about the rotational axis of the male portion, said lobes having rounded peripheral surfaces that engage the head-engaging surface portions of the female portion upon rotation of the members.

11. A method of rotatably coupling a first member having a first rotational axis to a second member having a second rotational axis, with said axes out of axial alignment, said method comprising the steps of:
providing a coupler having a female portion extending from one of the members, the female portion having at least one axially extending interior wall defining a socket, the wall having at least one head-engaging surface portion, a male portion extending from the other of the members, the male portion having a neck and a head, the head having at least one wall-engaging surface portion and being sized and adapted to be received in the socket, the male portion and female portion being shaped and adapted such that with the male portion positioned in the female portion and the members rotated, the wall-engaging surface portion engages the head-engaging surface portion and rotation of one member about its axis imparts rotation to the other member about its axis with the axes out of axial alignment;
inserting the male portion in the female portion; and
rotating one of the members about its axis to impart rotation to the other member about its axis with said axes out of axial alignment.

12. A method as set forth in claim 11 wherein the providing a coupler step further comprises providing a retainer located on the female portion, the retainer being shaped and adapted to prevent decoupling of the coupler during rotation.

13. A method as set forth in claim 11 wherein the male portion is positioned within a range of longitudinal positions in the female portion.
